(19) United States
(12) Patent Application Publication
(10) Pub. No.: US 2009/0024366 A1
(43) Pub. Date: Jan. 22, 2009

(54) COMPUTERIZED PROGRESSIVE PARSING OF MATHEMATICAL EXPRESSIONS

(75) Inventors: Seth Atkinson, Redmond, WA (US); Luke Kelly, Bellevue, WA (US); Jinsong Yu, Sammamish, WA (US); William Kunz, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/779,860

(22) Filed: Jul. 18, 2007

(51) Int. Cl. G06F 7/60

(52) U.S. Cl. 703/2

(57) ABSTRACT

Systems and methods for progressively parsing user input of a mathematical expression are provided. One disclosed method includes looping through characters in an input string, and on each loop, extracting a next token from the input string and determining a current grammar context based on the token or tokens extracted thus far. If it is determined that the current grammar context matches a predetermined condition, then the method may include modifying the tokens extracted from the input string in a predetermined manner associated with the predetermined condition. A parsing result may be obtained based on the modified tokens. The parsing result may be converted to a modified input string.

### BACKGROUND

Computer algebra systems are configured to receive user inputs of mathematical expressions, understand the inputs, and perform various tasks according to the inputs. Existing computer algebra systems apply strict syntactical rules to the mathematical expressions input by a user. This approach eliminates ambiguity in the interpretation of the inputs processed by the system, but can be difficult for users to learn due to the complexity of the syntactical rules. In addition, the mathematical notations used in mathematical textbooks and papers sometimes contain ambiguities. To remove these ambiguities, the syntactical rules of existing computer algebra systems often differ from the mathematical notations appearing in these textbooks and papers. This can be particularly frustrating to beginning users who are attempting to solve the problems appearing in these textbooks and papers using an existing computer algebra system.

Prior parsing techniques for user input of mathematical expressions involve tokenizing an entire input string, and then passing the tokens to a grammar analyzer to build up an expression tree. Thus, the user input is tokenized before the grammar analysis begins, and only lexical rules are used in the tokenization procedure. While these prior parsing techniques may be suitable for computer algebra systems that apply strict syntactical rules, these techniques suffer from the drawback that they cannot handle ambiguity in syntax, and thus cannot be used to process user input in a user-friendly manner.

### SUMMARY

Systems and methods for progressively parsing user input of a mathematical expression are provided. One disclosed method includes looping through characters in an input string, and on each loop, extracting a next token from the input string and determining a current grammar context based on the token or tokens extracted thus far. If it is determined that the current grammar context matches a predetermined condition, then the method may include modifying the tokens extracted from the input string in a predetermined manner associated with the predetermined condition. A parsing result may be obtained based on the modified tokens. The parsing result may be converted to a modified input string.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an embodiment of a system for progressively parsing user input of a mathematical expression.

FIG. 2A is a detail schematic view of a tokenizer and grammar analyzer of the system of FIG. 1, showing tokens and stacks used in parsing user input.

FIG. 2B is a detail schematic view of the stacks of FIG. 2A as used to process a different user input string.

FIG. 2C is a schematic view of expression trees utilized by the system of FIG. 1.

FIG. 3 is a flowchart of an embodiment of a method for progressively parsing user input of a mathematical expression.

FIG. 4A is a detail flowchart expanding on and illustrating substeps of the method of FIG. 3.

FIG. 4B is a continuation of the flowchart of FIG. 4A.

FIG. 4C is a continuation of the flowchart of FIG. 4B.

FIG. 5 is a schematic view of a graphical user interface of the system of FIG. 1.

FIG. 6 is a schematic view of another graphical user interface of the system of FIG. 1, illustrating an alternative output.

### DETAILED DESCRIPTION

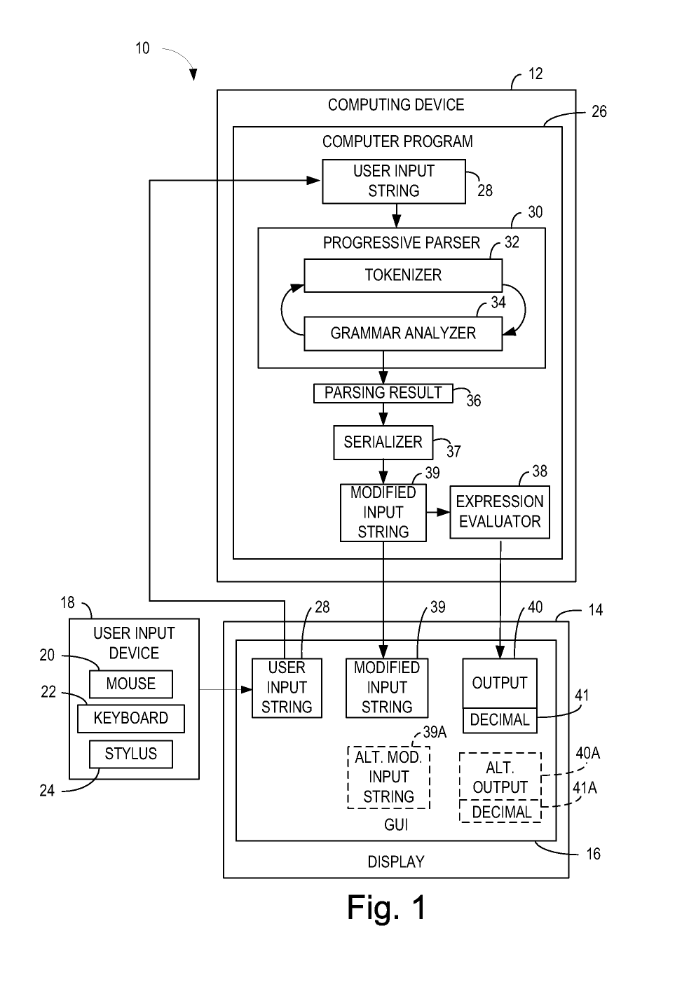

FIG. 1 illustrates a system 10 for progressively parsing user input of a mathematical expression. System 10 typically includes computing device 12 having an associated display 14 configured to display a graphical user interface 16, and one or more associated user input devices 18 such as a mouse 20, keyboard 22, or stylus 24. System 10 may further include a computer program 26 executable on the computing device 12 via a processor and portions of volatile and non-volatile memory. The computer program 26 may be configured to receive a user input string 28, via the GUI 16, the user input string representing a mathematical expression. A progressive parser 30 may include a tokenizer 32 and grammar analyzer 34 configured to parse the user input string 28 to obtain a parsing result 36. The computer program 26 may also include a serializer 37 configured to convert the parsing result 36 into a modified input string 39, which is readable by an expression evaluator 38.

The tokenizer 32 is configured to receive the input string via the graphical user interface of a computer program, and loop through the input string and extract a token from the input string during each loop. A token can be a number, a constant or variable name, an operator, a function name, or a whitespace, for example. The grammar analyzer 34 is configured to, during each loop, determine a current grammar context based on the token or tokens extracted thus far, determine whether the current grammar context matches a predetermined condition, and if the current grammar context matches the predetermined condition, modify the tokens extracted from the input string in a predetermined manner associated with the predetermined condition, to produce a modified input string, and update a current grammar context to prepare the next token for extraction.

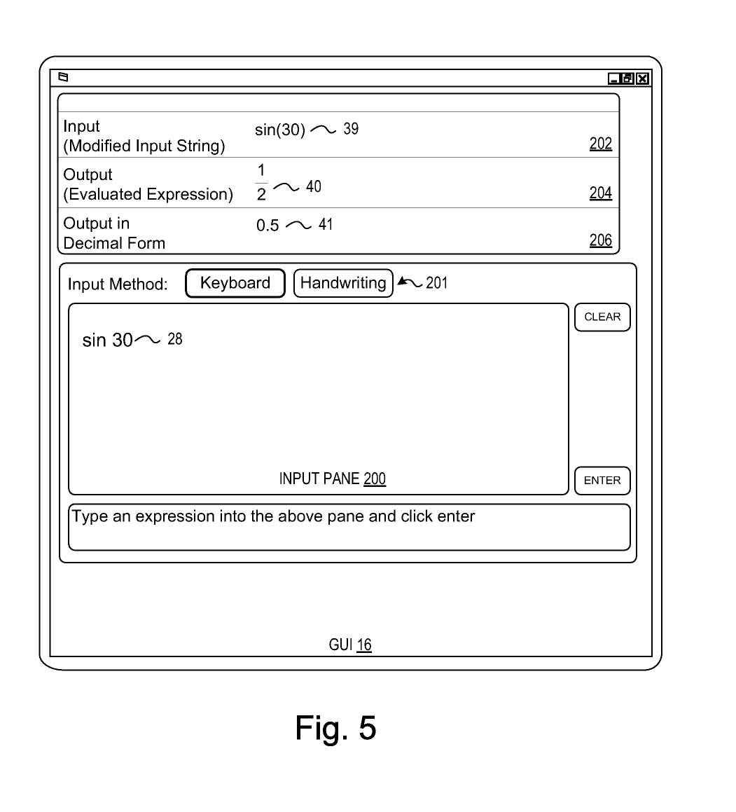

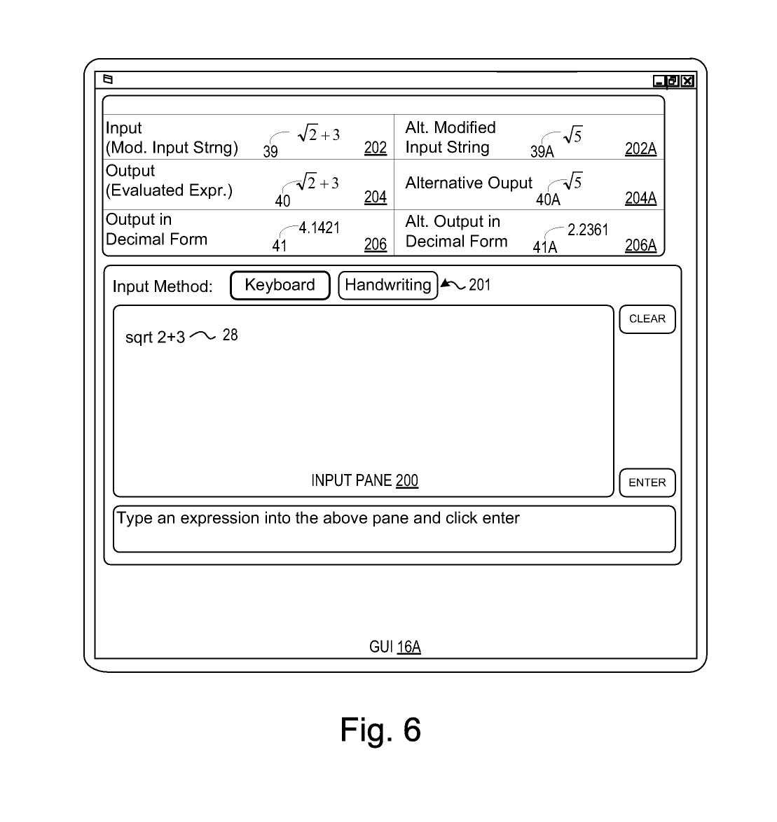

The progressive parser 30 is configured to obtain a parsing result 36 based on the modifications made to the tokens extracted from the input string during each loop. The parsing result 36 of the progressive parser 30 is configured to be output from the progressive parser 30 to a serializer 37, which converts the parsing result 36 into a modified input string 39. The modified input string 39 may be displayed on the GUI 16, and also may be sent to the expression evaluator 38 for evaluation. The expression evaluator 38 is configured to evaluate a mathematical expression contained in the modified input string 39, and display the resulting output 40 on the GUI 16, as further illustrated in FIG. 5. The output may be in a variety of forms such as a graph form or symbolic form, and/or may include a decimal form output 41. In some embodiments, the computer program 26 is configured to determine an alternative parsing result, which is converted into an alternative modified input string 39A, and the GUI 16 is configured to display at least one of the alternative modified input string 39A and a link to an alternative modified input string 39A, as further illustrated in FIG. 6. An alternative output 40A and associated decimal form output 41A from the expression analyzer 38 also may be displayed, as further illustrated in FIG. 6.

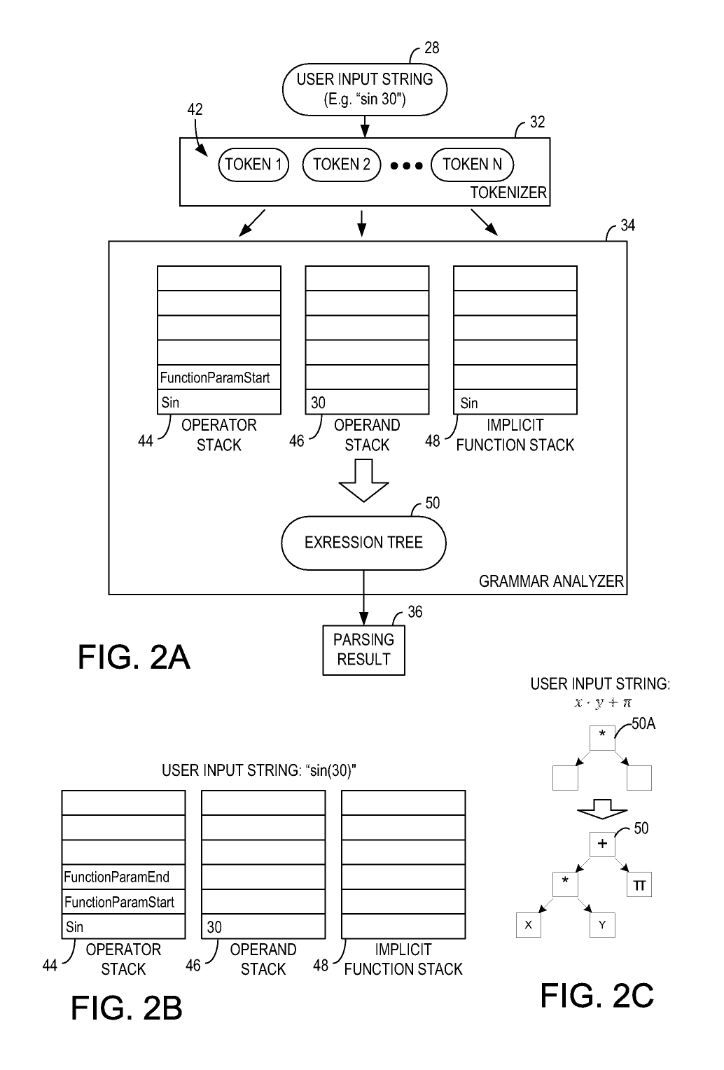

As shown in FIG. 2A, the tokenizer 32 is configured to progressively parse the user input string 28 into a series of tokens 42. The grammar analyzer 34 is configured to instantiate an operator stack 44, operand stack 46, and implicit function stack 48. Prior to obtaining the final parsing result 36, on each loop through the input string characters the grammar analyzer 34 is configured to place an extracted token in a selected one of the operator stack, operand stack and the implicit function stack. The grammar analyzer 34 is configured to analyze each token 42 in view of the current grammar context and determine whether the token 42 is an operator that should be placed in the operator stack 44 or an operand that should be placed in the operand stack 46. Further, when updating the grammar context to prepare for extraction of the next token, the grammar analyzer 34 may add a function to the implicit function stack 48, for future reference during parsing of the input string. The grammar analyzer 34 is configured to reference the implicit function stack 48, among other data, to ascertain a current grammar context for token extraction during each loop through the user input string 28.

In the example illustrated in FIG. 2A, “sin 30” is taken as the user input string 28, and “Sin” and “FunctionParamStart” are pushed to the operator stack 44, “30” is pushed to the operand stack 46, and “Sin” is entered into the implicit function stack 48. On the other hand, as illustrated in FIG. 2B, “sin (30)” is taken as user input string 28. In this case, no ambiguities are detected, “Sin” is pushed to the operator stack along with “FunctionParamStart” and “FunctionParamEnd”, and “30” is pushed to the operand stack. No entry is made in the implicit function stack since the last function parameter has been reached as indicated by the closed parentheses.

During parsing, the grammar analyzer 34 is configured to build a result expression tree 50 based on the contents of the operator stack 44, operand stack 46, and implicit function stack 48, and may also build temporary expression trees, such as 50A illustrated in FIG. 2C, during build up. The user input string 28 is typically parsed token by token, from beginning to end, i.e., left to right. Tokens indicating numbers, constants, variables, and any temporary expression trees are placed in the operand stack, while tokens indicating operators and function names are pushed into the operator stack. The operators have an associated precedence to determine an order of operation. Before an operator or function name is pushed into the operator stack, its precedence is compared with the precedence of the top element in the stack. If the top element in the stack has higher precedence, then the top element is removed from the stack, and the operands of the top element are also removed from the operand stack. A temporary expression tree is built up using these removed elements, and the result is placed back into the operand stack. Parentheses are paired up during the procedure and when the end of the expression is reached the grammar analyzer builds the result expression tree 50.

As illustrated in FIG. 2C, upon receiving the input string “x·y÷π”, the grammar analyzer 34 would receive a first token “x” from the tokenizer 32 and would place this token into the operand stack. Next, the grammar analyzer 34 would receive the token “·”, which would be placed into the operator stack, and would receive the token “y” which would be placed into the operand stack. The next operator in the input string is “+”, however “+” has a lower precedence than “·”, therefore “·” is removed from operator stack, and “y” and “x” are removed from operand stack, and a temporary expression tree of the form shown at 50A in FIG. 2C would be built and pushed into the operand stack. Next, the grammar analyzer 34 would place the token “+” into operator stack, and the token “π” into the operand stack. The grammar analyzer would then detect that the end of the input string is reached, and result expression tree 50 would be built up, by removing the operator “+” from operator stack, and removing the operand “π” and the temporary expression tree 50A from the operand stack, and the parsing result 36 would be obtained. This parsing result 36 may be passed along for display on GUI 16 and/or evaluation by expression evaluator 38, as discussed above.

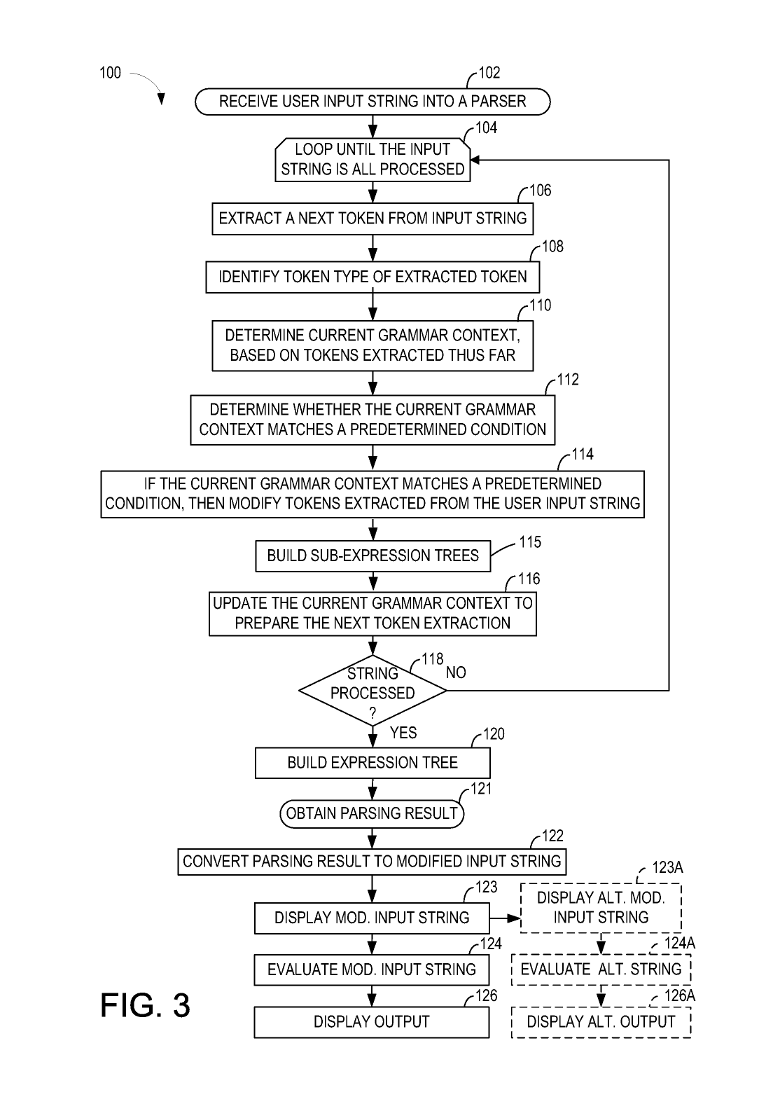

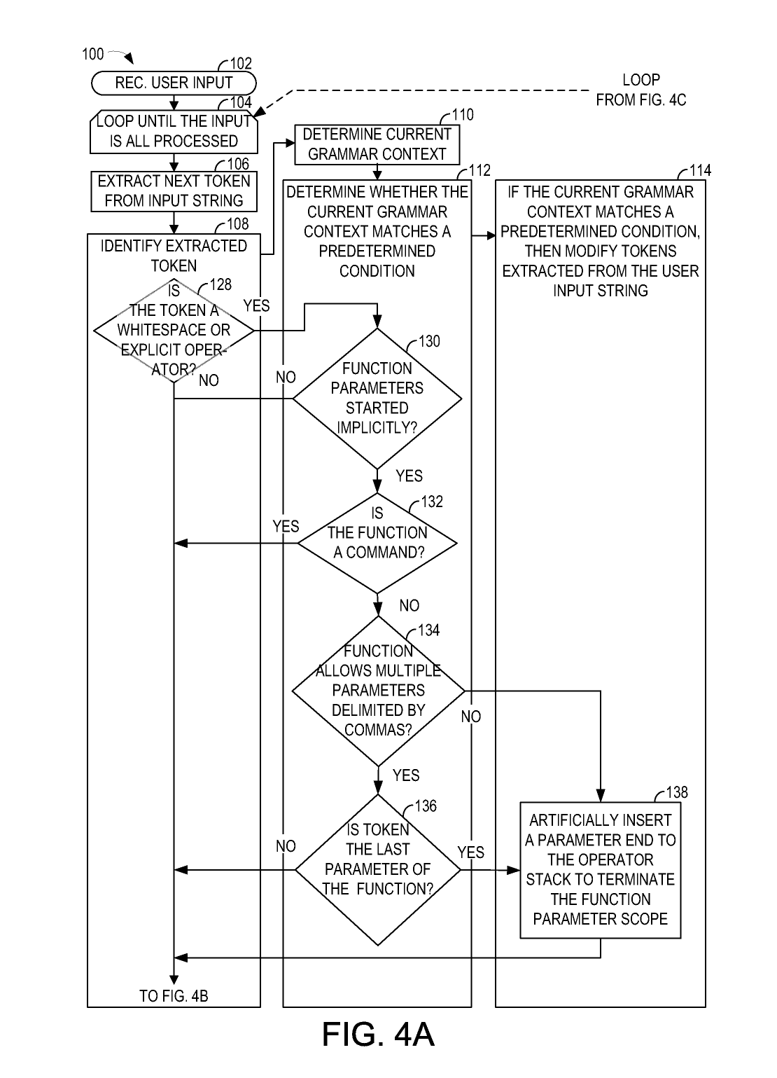

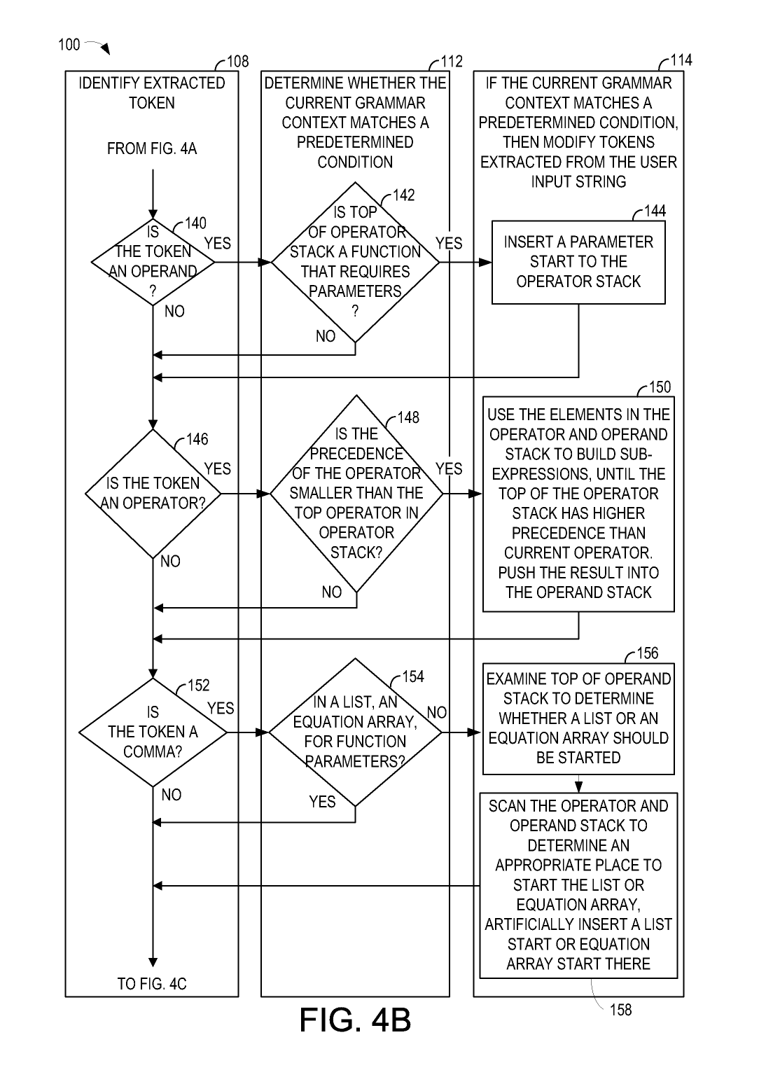

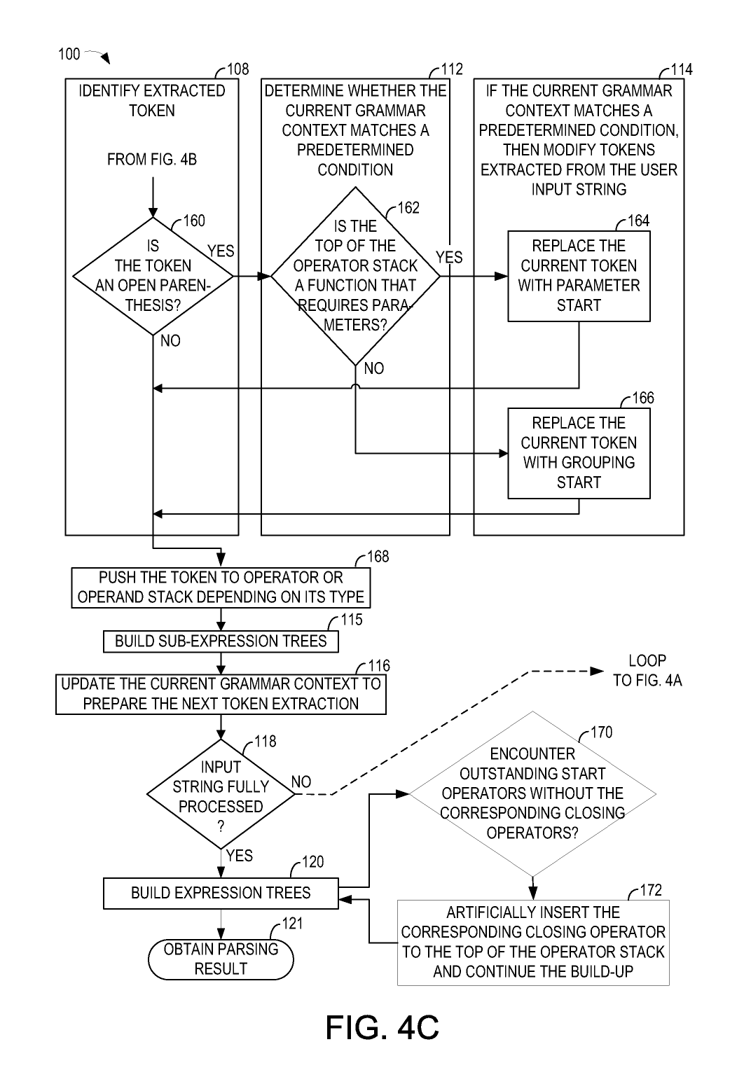

FIG. 3 illustrates one embodiment of a method 100 for progressively parsing user input of a mathematical expression. As illustrated at 102, method 100 may include receiving an input string into a parser via a graphical user interface of a computer program. At 104, the method includes looping through characters in the string until the string is fully processed. On each loop, the steps illustrated at 106-116 are performed. At 106, the method includes extracting a next token from the input string. At 108, the method includes identifying a token type of the extracted next token. Various token types that may be identified are further illustrated in FIGS. 4A-4C, discussed below.

At 110, the method includes determining a current grammar context based on the token or tokens extracted thus far. Various token types that may be identified are further illustrated in FIGS. 4A-4C, discussed below. At 112, the method includes determining whether the current grammar context matches a predetermined condition. Examples of the various predetermined conditions are further illustrated in FIGS. 4A-4C, discussed below. At 114, the method includes, if the current grammar context matches a predetermined condition, modifying the tokens extracted from the input string in a predetermined manner associated with the predetermined condition, to produce a modified input string. Modifications that may be made to the input string are further illustrated in FIGS. 4A-4C, discussed below. At 115, the method may include, during each loop building up sub-expression trees based on the tokens extracted thus far, as modified by the techniques discussed above. Typically, the expression tree is built up based on the contents of the operator stack, operand stack and implicit function stack, as discussed above. At 116, the method may include updating the current grammar context to prepare the next token for extraction. The updating may be accomplished by, for example, making or deleting an entry in the implicit function stack 48.

At 118, the method may include, determining whether the input string is fully processed, and if not, looping back to step 104. If it is determined that the user input string is fully processed, the method may include, at 120, building up an final expression tree based on all of the extracted tokens, as modified by the techniques discussed above. As at 115, the expression tree is built up based on the contents of the operator stack, operand stack and implicit function stack, as discussed above.

At 121, the method includes obtaining a parsing result based on the modified tokens. The parsing result may be obtained by compiling the expressions of the expression tree to obtain the parsing result. At 122, the method includes converting the parsing result to a modified input string. This may be performed, for example, by a serializer 37 that converts a parsing result into a text string, as described above. At 123, the method includes displaying the parsing result on the GUI 16. At 123A, the method may include displaying an alternative modified input string on the GUI, which is based on an alternative parsing result. At 124, the method may include evaluating a mathematical expression contained in the modified input string, and at 126, displaying a resulting output on the graphical user interface. At 124A, the alternative modified input string may be evaluated, and at 126A the resulting output be displayed. It will be appreciated that a link may alternatively be displayed to the alternative output and/or the alternative modified input string, as discussed above.

FIG. 4A is a detail flowchart expanding on and illustrating substeps of the method of FIG. 3. Steps 102-114 are described above, and will not be redescribed in detail, except in relation to the various substeps described below. As shown at 128, identifying the token type may include identifying the token type as a whitespace token or explicit operator. As shown at 130-136, upon making the identification at 128, determining whether the grammar context matches a predetermined condition may include (a) determining at 130 that one or more function parameters in the input string have been started implicitly; (b) determining at 132 that the function is not a command; (c) determining at 134 that the function allows multiple parameters delimited by commas; and (d) determining at 136 that the extracted token is the last parameter of the function. As illustrated at 138, upon determining that the aforementioned predetermined conditions are met, modifying the tokens extracted from the input string in a predetermined manner may include inserting a parameter end to the operator stack to terminate a function parameter scope. In addition, if it is determined at 130 that one or more function parameters in the input string have been started implicitly and at 132 that the function is not a command, but is determined at 134 that the function does not allow multiple parameters delimited by commas, then the method may also proceed to 138 and the tokens extracted from the input string may be modified by inserting a parameter end to the operator stack to terminate a function scope.

Turning now to FIG. 4B, as shown at 140, identifying the token type may include identifying the token type as an operand. Once so identified, as illustrated at 142, determining whether the grammar context matches a predetermined condition may include determining that a top of the operator stack is a function that requires parameters. If the top of the operator stack is determined to be a function that requires parameters, then as shown at 144, modifying the tokens extracted from the input string in a predetermined manner may include inserting a parameter start to the operator stack.

As shown at 146, identifying the token type may include identifying the token type as an operator. Once so identified, as shown at 148, determining whether the grammar context matches a predetermined condition may include determining that a precedence of the operator of the extracted token is smaller than the precedence of a top operator in the operator stack. If it is determined that the precedence of the operator of the extracted token is smaller than the precedence of the top operator, then as shown at 150, modifying the tokens extracted from the input string in a predetermined manner may include using the elements in the operator and operand stack to build sub-expressions, until a top of the operator stack has a higher precedence than the current operator, and pushing the result into the operand stack.

As shown at 152, identifying the token type may include identifying the token type as a comma. Once so identified, as illustrated at 154, determining whether the grammar context matches a predetermined condition may include determining that the comma is a delimiting comma in a list or an equation array of function parameters. If such a determination is made, as shown at 156, modifying the tokens extracted from the input string in a predetermined manner may include examining a top of the operand stack to determine whether a list or equation array should be started, scanning the operator and operand stack to determine a location to start the list or equation array, and as shown at 158, inserting a list start or equation array start in the determined location.

As shown at 160, identifying the token type may include identifying the token type as an open parenthesis. Once so identified, as shown at 162, determining whether the grammar context matches a predetermined condition may include determining whether a top of the operator stack is a function that requires parameters. As shown at 164, upon determining that the top of the operator stack is a function that requires parameters, modifying the tokens extracted from the input string in a predetermined manner may include replacing the current token with a parameter start. An example of such a modification is illustrated in FIG. 2A. As shown at 166, upon determining that the top of the operator stack is not a function that requires parameters, modifying the tokens extracted from the input string in a predetermined manner may include replacing the current token with a grouping start.

At 168, the method may further include, prior to obtaining the parsing result, placing the next token in a stack selected from the group consisting of an operator stack, operand stack and implicit function stack, as appropriate under the rules described above.

Steps 115-121 are similar to those described above and will not be redescribed in detail. It will be appreciated that during the step of building the subexpression trees at 120, the method may further include, as shown at 170, encountering an outstanding start operator without a corresponding closing operator, and as shown at 172, inserting a corresponding closing operator at the top of the operator stack. After the parsing result is obtained at 121, it will be appreciated that the method may continue to step 122 in FIG. 3.

It will be appreciated that the current grammar context may be determined to match the predetermined conditions described above by referencing a function start flag that is attached to each token that is a function operator designated to accept at least one parameter. For example, the flag may include the function name, an indication of whether the function accepts comma-delimited lists or arrays, and an indication of whether the lists or arrays accepted by the function are of a fixed size.

FIG. 5 illustrates a GUI 16 of system 10, which includes a user input pane 200 configured to receive at least one of typed input or handwriting input of a user input string 18. An input selector 201 may be provided to enable the user to select between handwritten and typed input methods. A modified input pane 202 may be provided to display modified input string 39, an output pane 204 may be provided to display output 40, and a decimal output pane 206 may be provided to display decimal form output 41. Upon entry of the user input string 18 and selection of the “enter” selector, the modified input string, output, and decimal form output may be displayed substantially simultaneously in the modified input pane 202, output pane 204, and decimal output pane 206. In the illustrated example, the user input string “Sin 30” is parsed to produce a modified input string of “Sin(30)”, which in turn is evaluated to produce corresponding output of ½ and corresponding decimal output of 0.5.

FIG. 6 illustrates a GUI 16A of system 10 configured similarly to GUI 16 described above, and is additionally provided with an alternative modified input pane 202A configured to display an alternative modified input string 39A, an alternative output pane 204A configured to display an alternative output 40A, and an alternative decimal output pane 206A configured to display an alternative decimal output 4 1A. Alternatively, a link may be provided to one or more alternative modified input strings, and the user may traverse the link to cause an alternative modified input string to be evaluated. In the depicted embodiment the user input string “sqrt 2+3” is parsed to yield a modified input string of \sqrt{2}+3, an output of the same form, and a decimal output of 4.1421. An alternative modified input string of \sqrt{5} is also displayed, as well as an alternative output of the same form and a decimal form output of 2.2361.

The above described systems and method may be used to enable more user friendly input processing, by progressively parsing user input mathematical expressions and modifying the input string as appropriate according to an updated grammar context of the input string, to thereby accommodate variations in syntax such as appear in mathematical textbooks and papers.

### EXAMPLES

The systems and method described above may be used to parse a variety of mathematical expressions. The following chart illustrates various user input strings, and associated modified input string, output, and decimal form output, that may be calculated according to the systems and method described above.

| | Modified input | | Decimal Form |
|---|---|---|---|
| User Input String | string | Output | Output |
| sin(30) | sin(30) | ½ | 0.5 |
| sin 30 | sin(30) | ½ | 0.5 |
| sin30 | sin(30) | ½ | 0.5 |
| sin 30x | sin(30x) | sin(30x) | — |
| sin 30 + x | sin(30) + x | $x + \frac{1}{2}$ | — |
| sin 30 · x | sin(30)x | x/2 | — |
| sqrt 2 + 3 | \sqrt{2} + 3 | \sqrt{2} + 3 | 4.1421 |
| mean 1,1,1,2 + 3 | mean(1,1,1,2+3) | 8/3 | 2.6667 |
| sin x + cos x | sin(x) + cos(x) | sin(x) + cos(x) | — |
| plot sin x + cos x | plot(sin(x)+cos(x)) | Graph Output | — |
| sin xy | sin (x y) | sin (x y) | — |
| sin x y | sin(x)y | y sin(x) | — |

The following list further illustrates the manner in which the systems and methods described above can be used to enable flexible parsing of various user inputs.

1. Users can use parentheses both for a grouping purpose and as a function parameter boundary. For example, both “3·(x+π)” and “max(3, 2, 2.5)” are allowed.

2. Users can omit the parentheses when used as function parameter boundary, and the expression will be parsesd in a sensible way. For example, “sin 30x” may be interpreted as “sin(30˜x)”, “sin 30+x” may be interpreted as “(sin(30))+x”, and “max 3, 2, 2.5” may be interpreted as “max(2, 3, 2.5)”.

3. Users don't have to use whitespaces to separate keywords. For example, “xln sin x” should be interpreted as “x·ln(sin(x))”.

4. Users can omit a closing parentheses and the system will automatically add a closing parenthesis in a sensible way. For example, “3·(x+π” is accepted and interpreted as “3·(x+π)”.

5. While curly braces may be used to denote lists (e.g. “{1,2,3}”), users can omit the curly braces and type in only the comma delimited list “1,2,3”, and the system will interpret the input string as “{1,2,3}”.

6. Users can input in comma-delimited equations to represent an equation system. For example, “x+y=3, 3x−2y=5” may be interpreted as

$$“ \{ \begin{matrix}x & + & y = 3 \\ 3 x & & 2 y = 5\end{matrix} ” .$$

It will be appreciated that the computing devices described herein may be any suitable computing device configured to execute the programs and display the graphical user interfaces described herein. For example, the computing devices may be a personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for progressively parsing user input of a mathematical expression, the method comprising:
receiving an input string into a parser via a graphical user interface of a computer program;
looping through characters in the input string until the input string is fully processed, and on each loop:
extracting a next token from the input string;
determining a current grammar context based on the token or tokens extracted thus far;
determining whether the current grammar context matches a predetermined condition;
if the current grammar context matches a predetermined condition, modifying the tokens extracted from the input string in a predetermined manner associated with the predetermined condition; and
obtaining a parsing result, based on the modified tokens; and
converting the parsing result to a modified input string.

2. The method of claim 1, further comprising displaying the modified input string on the graphical user interface.

3. The method of claim 2, further comprising displaying an alternative modified input string on the graphical user interface.

4. The method of claim 1, further comprising evaluating a mathematical expression contained in the modified input string, and displaying a resulting output on the graphical user interface.

5. The method of claim 1, further comprising, prior to obtaining the modified input string:
placing the next token in a stack selected from the group consisting of an operator stack, operand stack and implicit function stack; and
updating the current grammar context to prepare the next token for extraction.

6. The method of claim 5, further comprising, prior to determining a grammar context, identifying a token type of the extracted next token.

7. The method of claim 6,
wherein identifying the token type includes identifying the token type as a whitespace token or explicit operator;
wherein determining whether the grammar context matches a predetermined condition includes (a) determining that one or more function parameters in the input string have been started implicitly; (b) determining that the function is not a command; (c) determining that the function allows multiple parameters delimited by commas; and (d) determining that the extracted token is the last parameter of the function; and
wherein modifying the tokens extracted from the input string in a predetermined manner includes inserting a parameter end to the operator stack to terminate the function parameter scope.

8. The method of claim 6,
wherein identifying the token type includes identifying the token type as an operand;
wherein determining whether the grammar context matches a predetermined condition includes determining that a top of the operator stack is a function that requires parameters; and
wherein modifying the tokens extracted from the input string in a predetermined manner includes inserting a parameter start to the operator stack.

9. The method of claim 6,
wherein identifying the token type includes identifying the token type as an operator;
wherein determining whether the grammar context matches a predetermined condition includes determining that a precedence of the operator is smaller than a precedence of a top operator in the operator stack; and
wherein modifying the tokens extracted from the input string in a predetermined manner includes using elements in the operator and operand stack to build sub-expressions, until a top of the operator stack has a higher precedence than the current operator, and pushing a result into the operand stack.

10. The method of claim 6,
wherein identifying the token type includes identifying the token type as a comma;
wherein determining whether the grammar context matches a predetermined condition includes determining that the comma is a delimiting comma in a list or an equation array of function parameters; and
wherein modifying the tokens extracted from the input string in a predetermined manner includes examining a top of the operand stack to determine whether a list or equation array should be started, scanning the operator and operand stack to determine a location to start the list or equation array, and inserting a list start or equation array start in the determined location.

11. The method of claim 6,
wherein identifying the token type includes identifying the token type as an open parenthesis;
wherein determining whether the grammar context matches a predetermined condition includes determining whether a top of the operator stack is a function that requires parameters;
wherein, upon determining that the top of the operator stack is a function that requires parameters, modifying the tokens extracted from the input string in a predetermined manner includes replacing the current token with a parameter start; and
wherein, upon determining that the top of the operator stack is not a function that requires parameters, modifying the tokens extracted from the input string in a predetermined manner includes replacing the current token with a grouping start.

12. The method of claim 5, further comprising:
building up a sub-expression tree based on contents of the operator stack, operand stack and implicit function stack; and
compiling sub-expressions of the sub-expression tree to obtain the parsing result.

13. The method of claim 6, wherein building up the sub-expression tree, includes:
encountering an outstanding start operator without a corresponding closing operator; and
inserting a corresponding closing operator at the top of the operator stack.

14. The method of claim 1, wherein the extracted token is a function, and the current grammar context is determined by referencing a function start flag that is attached to the extracted token.

15. A system for progressively parsing user input of a mathematical expression, comprising:
a computer program executable on a computing device, the computer program including a progressive parser having a tokenizer and a grammar analyzer;
wherein the tokenizer is configured to receive an input string via the graphical user interface of a computer program, and loop through the input string to extract a token from the input string on each loop;
wherein the grammar analyzer is configured to, on each loop, determine a current grammar context based on the token or tokens extracted thus far, determine whether the current grammar context matches a predetermined condition, and if the current grammar context matches the predetermined condition, modify the tokens extracted from the input string in a predetermined manner associated with the predetermined condition, and update a current grammar context to prepare the next token for extraction;
wherein the progressive parser is configured to obtain a parsing result based on the modified tokens; and
wherein the computer program further includes a serializer configured to convert the parsing result to a modified input string; and
wherein the computer program is configured to display the modified input string on a graphical user interface.

16. The system of claim 15, wherein the graphical user interface includes a user input pane configured to receive at least one of typed input or handwriting input.

17. The system of claim 15, wherein the computer program is configured to determine an alternative modified input string and the graphical user interface is configured to display at least one of the alternative modified input string and a link to an alternative modified input string.

18. The system of claim 15, wherein the computer program further includes an expression evaluator configured to evaluate the modified input string to produce an output, and wherein the graphical user interface is configured to display the output of the expression evaluator.

19. The system of claim 15, wherein the grammar analyzer is configured to instantiate an operator stack, operand stack and implicit function stack, and wherein prior to obtaining the parsing result the grammar analyzer is configured to place the next token in a selected one of the operator stack, operand stack and the implicit function stack.

20. Computer-readable media having program instructions stored thereon, which upon execution by a computing device, cause the computing device to execute a method comprising:
receiving an input string into a parser via a graphical user interface of a computer program;
looping through characters in the input string until the input string is fully processed, and on each loop:
extracting a next token from the input string;
determining a current grammar context based on the token or tokens extracted thus far;
determining whether the current grammar context matches a predetermined condition;
if the current grammar context matches a predetermined condition, modifying tokens extracted from of the input string in a predetermined manner associated with the predetermined condition;
obtaining a parsing result, based on the modified tokens; and
converting the parsing result to a modified input string.
